(19) United States
(12) Patent Application Publication
(10) Pub. No.: US 2007/0241581 A1
(43) Pub. Date: Oct. 18, 2007

(54) Debris deflector for automobile seats and method of using same

(76) Inventor: Mark Martin, Flushing, MI (US)

Correspondence Address: YOUNG & BASILE, P.C., 3001 WEST BIG BEAVER ROAD, SUITE 624, TROY, MI, 48084, US

(21) Appl. No.: 10/998,873

(22) Filed: Nov. 29, 2004

(51) Int. Cl. B60R 7/00

(52) U.S. Cl. 296/37.8

(57) ABSTRACT

The specification discloses a debris deflector for occupying a gap disposed between, and having a shape and a width at least partially defined by, an automobile seat and an adjacent console. The deflector consists essentially of a resiliently deformable material and has a width greater than the width of the gap. The deflector is capable of reversible compressible conformation to the shape of the gap so as to obstruct the passage of objects into the gap. The specification further discloses a method for using such a debris deflector.

### CROSS-REFERENCE TO RELATED APPLICATIONS

Not applicable. STATEMENT REGARDING FEDERALLY SPONSORED RESEARCH OR DEVELOPMENT

Not applicable. INCORPORATION BY REFERENCE OF MATERIAL SUBMITTED ON A COMPACT DISC

Not applicable.

### FIELD OF THE INVENTION

The present invention pertains generally to debris deflectors, and more specifically to a debris deflector for occupying a gap disposed between, and having a shape and a width at least partially defined by, an automobile seat and an adjacent console, the deflector consisting essentially of a resiliently deformable material capable of reversible compressible conformation to the shape of the gap so as to obstruct the passage of objects into the gap.

### BACKGROUND OF THE INVENTION

The accumulation of debris between the passenger or driver's seat of an automobile and the adjacent console is a common, long-suffered aggravation. Conventionally, few solutions have been offered to this problem. And those that do exist are impractical or, at best, only partial solutions. For instance, Kopinski et al., U.S. Pat. No. 5,887,941, discloses an automobile cleaning apparatus comprising a removable receptacle formed from a rigid material, the receptacle adapted for placement on the floor of an automobile beneath the gap defined between adjacent seat cushions or a seat and an adjacent console. As desired, the receptacle may be withdrawn from its position on the automobile floor and any contents which may have fallen therein removed. Alternatively, Saunders, U.S. Pat. No. 4,948,195, teaches a gap closer for automobile seats comprising a multi-part cardboard wedge having an intermediate elastomeric section for expending the sides of the wedge. In operation, the wedge is inserted into a gap between the automobile seat and console to prevent objects from dropping into this gap. The elastomeric section serves to maintain the wedge in position within the gap.

Unfortunately, the foregoing solutions are unsatisfactory. On the one hand, the apparatus of Kopinski et al. fails to prevent objects from falling into the gap between an automobile seat and adjacent console in the first instance. And while, on the other hand, the apparatus of Saunders does purport to achieve this objective, it does so with a device of unnecessarily complicated construction, and which is otherwise limited in its applicability by the fact that the rigid sidewalls if the wedge are unable to conform to gaps of irregular shape (i.e., gaps whose sides do not define parallel faces).

In order to remedy the deficiencies of the prior art, it would thus be advantageous to provide a debris deflector which is at once economical to manufacture, easy to employ, and serves to effectively prevent objects from falling into the gap defined between an automobile seat and an adjacent console.

### SUMMARY OF THE DISCLOSURE

The present invention addresses and solves the problems discussed above, and encompasses other features and advantages, by providing a debris deflector for occupying a gap disposed between, and having a shape and a width at least partially defined by, an automobile seat and an adjacent console. The deflector consists essentially of a resiliently deformable material and has a width greater than the width of the gap. The deflector is capable of reversible compressible conformation to the shape of the gap so as to obstruct the passage of objects into the gap.

According to one feature of this invention, the deflector is of monolithic construction.

According to another feature hereof, the deflector is characterized by a trapezoidal cross-section facilitating insertion of the deflector into the gap, the trapezoidal shape defined by a top surface having a width greater than the width of the gap to be occupied, and a bottom surface having a width less than the width of the gap to be occupied.

Per yet another feature of this invention, the deflector further comprises at least one recess for holding objects, such as, for instance, a cellular telephone, coins, etc. This recess may, according to one embodiment, be formed as a cut-out, or, alternatively, may be defined by a separate polymeric insert.

According to a further feature, wherein the automobile seat and adjacent console defining the gap are characterized by at least a first color, the deflector is colored to approximate the at least first color.

The present invention further comprehends a method for obstructing the passage of debris into a gap disposed between, and having a shape and a width at least partially defined by, an automobile seat and an adjacent console, the method comprising the steps of: Providing a deflector consisting essentially of a resiliently deformable material and having a width greater than the width of the gap, the deflector being capable of reversible compressible conformation to the shape of the gap so as to obstruct the passage of debris into the gap; orienting the deflector so that the width thereof is aligned with the width of the gap; and urging the deflector into the gap so that the deflector compressibly conforms to the shape of the gap to thus obstruct the passage of debris into the gap.

According to one feature of this method, the deflector provided in the first step is of monolithic construction.

According to another feature hereof, the deflector provided in the first step is characterized by a trapezoidal cross-section facilitating insertion of the deflector into the gap.

Per yet another feature of this inventive method, the deflector provided in the first step further comprises at least one recess for holding objects, such as, for instance, a cellular telephone, coins, etc. This recess may, according to one embodiment, be formed as a cut-out, or, alternatively, may be defined by a separate polymeric insert.

According to a further feature hereof, wherein the automobile seat and adjacent console defining the gap are characterized by at least a first color, the deflector provided in the first step is colored to approximate the at least first color.

### BRIEF DESCRIPTION OF THE DRAWINGS

FIG. 1 is an elevational view depicting the deflector of the present invention in operational position between an automobile seat and adjacent console;

FIG. 2 is a perspective view of a first embodiment of the present inventive deflector; and

FIG. 3 is a perspective view of a second embodiment of the present inventive deflector.

### WRITTEN DESCRIPTION

Referring now to the drawings, wherein like numerals indicate like or corresponding parts among the several views, the present invention will be seen to most generally comprise a debris deflector 10 for occupying a gap G disposed between, and having a shape and a width at least partially defined by, an automobile seat 20 and an adjacent console 25.

Referring particularly to FIG. 3, the deflector 10 consists essentially of resiliently deformable material, including, without limitation, one or more closed or open cell foams of polyethylene, polyurethane, neoprene, vinyl foam rubber, or any other material capable of reversible compressible conformation to the shape of the gap G. The deflector 10 has a width 11 greater than the width of the gap G, as well as a length 12, so as to be able, in operation, to completely span the width of the gap G and, preferably, substantially fill the length of the gap, thus at least significantly obstructing the passage of objects into the gap G.

Still referring to FIG. 3, the debris deflector 10 is, according to the illustrated embodiment, monolithic in construction. Alternatively, the deflector of this invention may be of unitary construction comprising multiple separate elements.

The debris deflector 10 may be constructed by shaping the selected resiliently deformable material to appropriate dimensions by extrusion, die cutting, wire block cutting, molding, casting, or other conventional methods.

As shown in FIG. 3, the deflector 10 may be characterized by a trapezoidal cross-section defined by a top surface 13 having a width greater than the width of opposite bottom surface 14, and inwardly sloping sides 15. The width defined by the top surface 13 is greater than the width of a gap G, while the width defined by the bottom surface 14 is smaller than the width of the same gap G. By this configuration, it will be appreciated that insertion of the deflector into a gap is facilitated. Of course, the foregoing configuration is not intended to be limiting, and it will be understood that the debris deflector 10 of this invention may be produced in numerous shaped and sizes in order to best accommodate the shape and dimensions of any desired gap to be obstructed.

Referring now to FIG. 2, an alternate embodiment of the debris deflector 10′ of this invention is shown to include at least one recess 16 for holding objects, including, for example, coins, cellular telephones, pens, etc. As depicted, the recess 16 is defined out of the body of the deflector 10, for instance by cutting out a portion of the resiliently deformable material to define a recess of desired dimensions, by molding the deflector 10′ to include the recess 16, etc. Alternatively, the recess 16 may be defined by a polymeric insert (not shown) formed separately from the deflector 10 and subsequently disposed thereon.

Though not representable in the drawings, it is contemplated that the deflector of this invention may be colored, including a color which at least approximates the color of the automobile seat and adjacent console defining the gap. Such color may be imparted through any conventional means, including the application of a paint or other colored coating to the deflector 10, by fabricating the deflector 10 in the desired color, etc. As will be appreciated, the provision of a deflector 10 in a color at least approximating the color of the automobile seat and adjacent console defining the gap serves to render the deflector 10 less obtrusive in the environment of the automobile cabin.

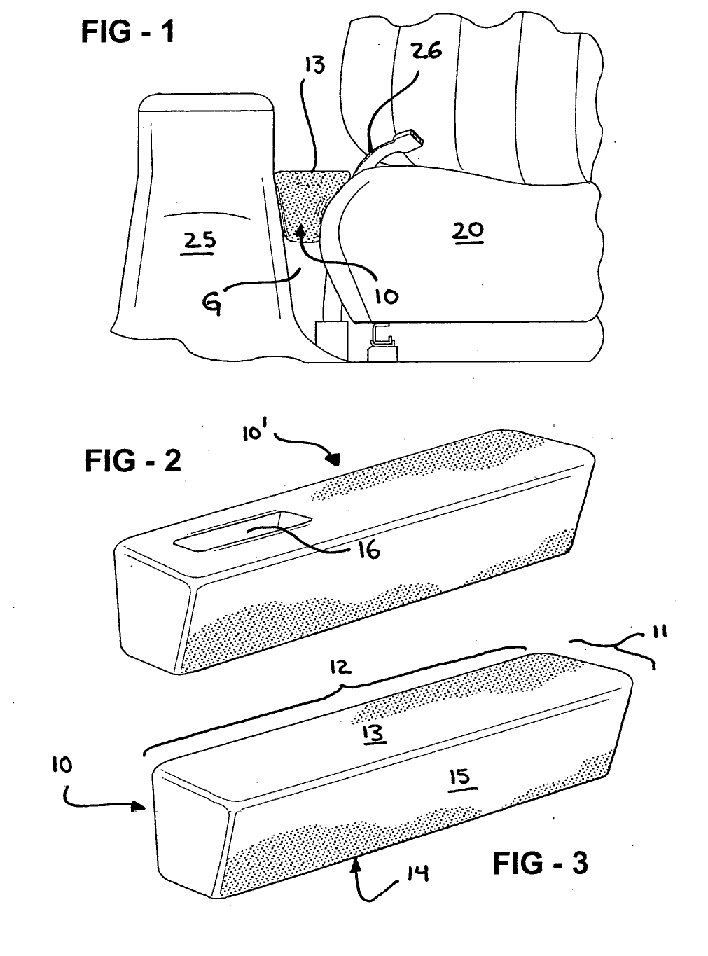

Referring specifically to FIG. 1, operation and employment of the debris deflector 10 of this invention will be better understood. More particularly, the deflector 10 is oriented so that the at least width thereof is aligned with the width of the gap G. Thus aligned, the deflector 10 is simply urged into the gap G by manually applying pressure to the debris deflector 10 such that resiliently deformable material thereof is compressed into conformance with the dimensions and shape of the gap G, by which action the deflector 10 completely spans the width of the gap G and substantially fills the length of the gap G so as to obstruct debris from passing into the gap G.

Once debris deflector 10 has been thus inserted into the gap G, the lateral pressure exerted by the resiliently deformable material thereof against the console 25 and seat 20 serves to support the debris deflector 10 in its desired position within the gap G.

It will be appreciated that the debris deflector 10 is preferably, though not exclusively, installed with its top surface 13 at least at an elevation substantially the same as the elevation of the seating surface of the automobile seat 20.

As will be appreciated, the deformable material of the debris deflector 10 will allow a seatbelt 26 or other convenience item to pass between the debris deflector 10 and adjacent seat 20 or console 25 while still permitting tight conformance of the debris deflector with the shape of the gap G. Likewise, the deformable material of the debris deflector 10 will permit close conformance of the deflector with gaps of myriad irregular shapes.

It will be appreciated from the above disclosure that the present invention improves upon the prior art by providing a debris deflector which is at once economical to manufacture, easy to employ, and serves to effectively obstruct the passage of objects into the gap disposed between an automobile seat and an adjacent console.

Of course, the foregoing is merely illustrative of the present invention, and those of ordinary skill in the art will appreciate that many additions and modifications to the present invention, as set out in this disclosure, are possible without departing from the spirit and broader aspects of this invention as defined in the appended claims.

1. A debris deflector for occupying a gap disposed between, and having a shape and a width at least partially defined by, an automobile seat and an adjacent console, the deflector consisting essentially of a resiliently deformable material and having at least a first width greater than the width of the gap, the deflector being capable of reversible compressible conformation to the shape of the gap so as to obstruct the passage of objects into the gap, and wherein further the defector is characterized by the absence of adhesive material for adhering the deflector to a surface.

2. The debris deflector of claim 1, wherein said deflector is of monolithic construction.

3. The debris deflector of claim 1, wherein said deflector is characterized by a trapezoidal cross-section defined by a top surface having a width greater than the width of the gap to be occupied, and a bottom surface having a width less than the width of the gap to be occupied.

4. The debris deflector of claim 1, wherein said deflector further comprises at least one recess for holding one or more objects.

5. The debris deflector of claim 4, wherein said at least one recess is a formed integrally with said deflector.

6. (canceled)

7. The debris deflector of claim 1, wherein the automobile seat and adjacent console at least partially defining the gap are characterized by at least a first color, and wherein further said deflector is colored to approximate the at least first color.

8. A method for obstructing the passage of objects into a gap disposed between, and having a shape and a width at least partially defined by, an automobile seat and an adjacent console, the method comprising the steps of:
providing a deflector consisting essentially of a resiliently deformable material and having at least a first width greater than the width of the gap, the deflector being capable of reversible compressible conformation to the shape of the gap so as to obstruct the passage of debris into the gap;
orienting said deflector so that the width thereof is aligned with the width of the gap; and
urging said deflector into the gap so that the deflector compressibly conforms to the shape of the gap to thus obstruct the passage of objects into the gap.

9. The method of claim 8, wherein the step of providing a deflector further comprises providing a deflector of monolithic construction.

10. The method of claim 8, wherein the step of providing a deflector further comprises providing a deflector characterized by a trapezoidal cross-section defined by a top surface having a width greater than the width of the gap to be occupied, and a bottom surface having a width less than the width of the gap to be occupied.

11. The method of claim 8, wherein the step of providing a deflector further comprises providing a deflector comprises at least one recess for holding objects.

12. The method of claim 11, wherein the step of providing a deflector further comprises providing a deflector wherein the at least one recess is a formed integrally with said deflector.

13. The method of claim 11, wherein the step of providing a deflector further comprises providing a deflector wherein the at least one recess is defined by a polymeric insert.

14. The method of claim 8, wherein the automobile seat and adjacent console defining the gap are characterized by at least a first color, and wherein the step of providing a deflector comprises providing a deflector that is colored to approximate the at least first color.
